(19) United States
(12) Patent Application Publication
(10) Pub. No.: US 2006/0095665 A1
(43) Pub. Date: May 4, 2006

(54) Real-time single hard disk data backup method

(76) Inventor: Ching-Lung Tsai, Hsinchu City (TW)

Correspondence Address: LIN & ASSOCIATES INTELLECTUAL PROPERTY, P.O. BOX 2339, SARATOGA, CA, 95070-0339, US

(21) Appl. No.: 10/980,493

(22) Filed: Nov. 2, 2004

(51) Int. Cl. G06F 12/16

(52) U.S. Cl. 711/114

(57) ABSTRACT

Disclosed is a real-time single hard disk data backup method, which divides a single hard disk area into two unit blocks through the use of software. At the same time, the data through the use of software will be backed up and stored in stripe block of different unit blocks of the same hard disk. Then with use of software, further divide a single hard disk area into 2n unit blocks; the software will select two unit blocks out of the multiple available in the array, and simultaneously store and retrieve data from the stripe block of those two unit blocks.

### BACKGROUND OF THE INVENTION

1. Field of the Invention

The present invention relates to real-time single hard disk data backup method, which, through the use of software, divides a single hard disk into two or more unit blocks. When the data is being backed up in real-time, it is simultaneously stored in a stripe block of different unit blocks belonging to the same hard disk.

2. The Prior Arts

In the field of databases and database storage, the usage of arrays is very popular. RAID1 is an easy-to-use real-time data backup technology. RAID1 stores data by writing the same data to two hard disks simultaneously. If the data in one of the hard disks is destroyed or, the other hard disk will immediately provide the same data to users. FIG. 1 of the attached drawings shows the RAID1 technique that eliminates the occurrence of irretrievable data. However, this technique requires two or more hard disks in order to complete the storage operation, and may present some limitations like: operation costs, or the situation where only one hard disk is available. If the two previously mentioned factors are considered, users may render the technology useless.

Presently, hard disk capacity is on the increase and, therefore, is even more likely to become damaged. If a bad sector of a hard disk is detected by a management system, the management system disregards the bad sector and does not use the hard disk. If the bad sector occurs when the management system is reading the hard disk for the stored data, the data stored within that hard disk will be lost.

The present invention takes into account the previous design flaws and improves it as stated below.

### SUMMARY OF THE INVENTION

The primary objective of the present invention is to logically divide a single hard disk into two or more unit blocks. When data is being backed up, it is stored on a stripe block of different unit blocks belonging to the same hard disk.

The secondary objective of this invention is to solve storage problem when there is only one available hard disk. This also prevents the occurrence of no data backup or damaged hard disk at retrieval time.

### BRIEF DESCRIPTION OF THE DRAWINGS

FIG. 1 is a schematic diagram showing the real-time backup of the same piece of data according to RAID1.

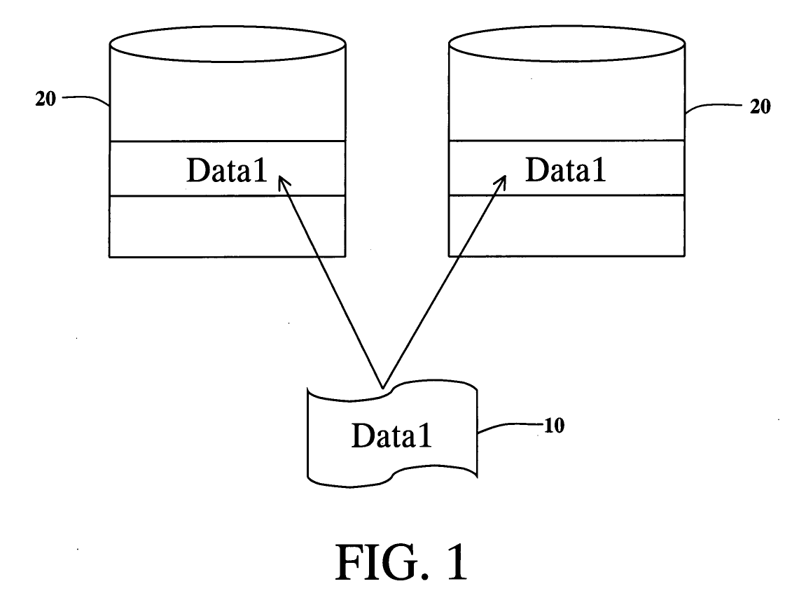

FIG. 2 is a schematic diagram showing the real-time backup of data according to the present invention.

FIG. 3 is another schematic diagram showing the division of data into more than two unit blocks according to the present invention.

### DETAILED DESCRIPTION OF THE PREFERRED EMBODIMENTS

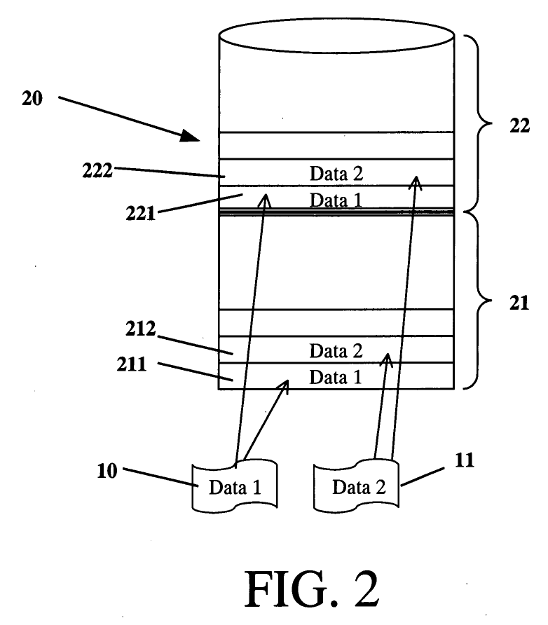

With reference to the drawings and in particular FIG. 2, through the use of software, hard disk (20) is divided into two unit blocks (21) and (22). When a piece of data (10) is to be backed up in real-time, through the use of software, data (10) is simultaneously stored in different unit blocks (21) and (22) of the same hard disk (20). With the two unit blocks, data (10) is specifically stored in stripe blocks (211) and

(221) respectively, thus completing the backup operation for data (10). If the next piece of data (11) was to be stored at the same time, the data will also be managed by software, and stored at different stripe blocks (212) and (222) of the unit blocks (21) and (22).

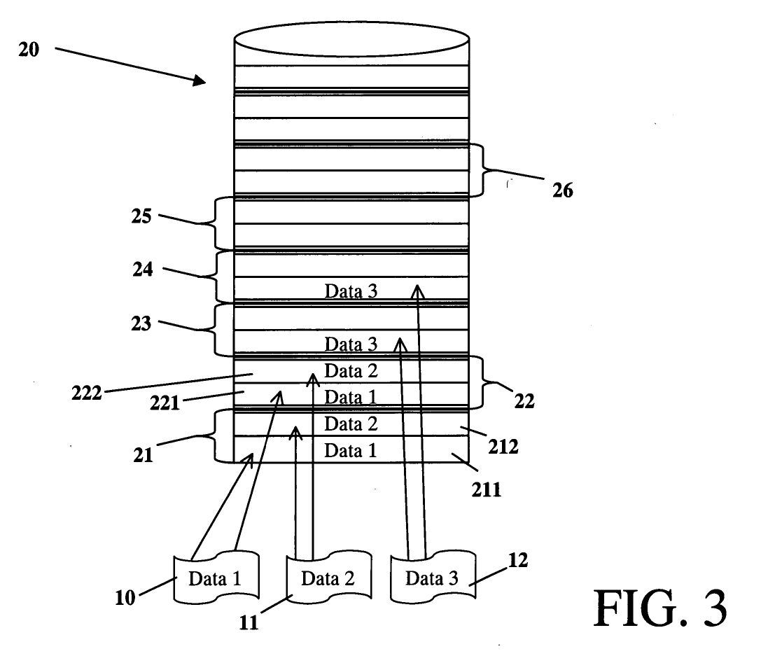

Referring to FIG. 3, the hard disk (20) through the use of software, is divided into multiple unit blocks (21), (22), (23), (24), (25) and (26). The software will select two unit blocks according to their order: in this case unit blocks (21) and (22) will be used for real-time backup. The next piece of data (11) will also be stored on the same hard disk (20), but in different stripe blocks (212) and (222) of the respective unit blocks (21) and (22), thus completing the backup operation for data (11).

If the unit blocks (21) and (22) are full, then the software will select the next two unit blocks in the order of the array: in this case unit blocks (23) and (24), for storage of data (12), and other pieces of data until unit blocks (23) and (24) is also full.

As the above example has demonstrated, any new data ready for real-time backup can be managed by this new real-time data management technique.

What is claimed:

1. A real-time single hard disk data backup method, through software to divide a single hard disk into two unit blocks, in which data to be stored is managed through the software to be simultaneously stored in stripe blocks of the two unit blocks of the hard disk.

2. The real-time single hard disk data backup method according to claim 1, wherein the hard disk is divided into a plurality of unit blocks, among which at least two are selected for simultaneously storing the same data.

3. The real-time single hard disk data backup method according to claim 2 further comprising a step of re-selecting unit blocks when the two unit blocks that are originally selected by the software is full and a step of storing daa to the newly selected unit blocks.
